(19) United States
(12) Patent Application Publication
(10) Pub. No.: US 2006/0041532 A1
(43) Pub. Date: Feb. 23, 2006

(54) System for automating the process of retrieving and replying to job postings

(76) Inventor: Momchil Borislavov Nikolov, Galesburg, IL (US)

Correspondence Address: MOMCHIL BORISCAVOV NIKOLOV, 1743 NORTH CHERRY STREET, GALESBURG, IL, 61401, US

(21) Appl. No.: 10/710,999

(22) Filed: Aug. 17, 2004

(51) Int. Cl. G06F 17/30

(52) U.S. Cl. 707/3

(57) ABSTRACT

A software internet-enabled system is described in order to search for and extract pre-specified patterns of data including electronic contact information and the subsequent automatic distribution of tailored material directed towards the aforementioned electronic contact information. One of the preferred applications of the system is the extraction of key job posting information from a plurality of job advertisements across multiple internet sites. The system returns a multitude of key job posting information further searchable and selectable. Finally, the system then facilitates the automated distribution of custom tailored job applications to the job advertisers.

### BACKGROUND OF INVENTION

The present invention is related to a desktop or internet application that automates the processes of searching and extracting job postings from a plurality of job sites and the subsequent application of the jobs through e-mail systems. Specifically, the invention allows a job seeker to target search a multitude of job boards and job sites for specific job opportunities constrained by search parameters such as employment discipline and location. The job seeker can further narrow down the returned results. The invention then allows the job seeker to automatically send tailored cover-letters as well as field-specific resumes to the email addresses of the advertising parties, such as employers and employment agencies comprising the results.

The internet has changed the way that job applicants and employers find each other. With the advent of internet job sites and job bulletin boards, jobseekers can search and respond to job postings from their home and send their resumes to interested parties electronically. The job seeker would typically spend many hours and very likely, days searching multiple job sites and then tailoring his cover letters to each specific job posting before he sends his job responses electronically. This is a time consuming processAnd the job applicant is limited normally limited by time constraints as well as to human speed and efficiency. This prevents him for responding to all job postings that he would like to respond to and all job posting that fit his search criteria.

### SUMMARY OF INVENTION

A system or computer application that automates the extensive process mentioned in the “Background of the Invention” section and saves many hours of searching and replying electronically to job postings.

Another system, resume blasting, offers the job seeker automated resume distribution to affiliated recruiters, human resource departments, and companies. Although resume blasting does provide the job seeker a more active means in the employment process, the service is limited by the number of the affiliated employers and recruiters. The present invention on the other hand offers an unlimited and faster growing set of contacts and employers as new job postings are added on a daily basis on a multitude of job boards. Furthermore, the distribution of a job candidate's resume is not targeted to a specific job opening but rather to discipline pertinent bodies who may not have a suitable job opening available.

Another recent innovations provides the job seeker with a more active and automated approach in the employment process. The aforementioned innovation offers to save the job seeker hours of time set aside for posting his/hers resume to a plurality of job sites by automatically posting resumes submitted in one place to the all of the related job sites. Although resume posting does increase the exposure of a job candidate's resume, prospective employers must still search through multiple resume pools located on multiple internet sites in order to locate a specific resume. Furthermore, the exposure of the resume is limited to the currently available number of job sites and job boards. Accordingly, the present invention enables the jobseeker to respond to a much larger pool of job opportunities and the employer to see a much larger pool of relevant candidates.

Heretofore there has not been available a system allowing a job seeker to target search a virtually unbounded job pool available on the internet and to automatically distribute tailored resumes and cover letters to the aforementioned specific job opportunities.

### DETAILED DESCRIPTION

The system consists of two main parts or components.

The first part or component is system 1, which I shall designate as the “extractor”. And I will refer to the second part (system 2) as the composer/mailer. The extractor searches and extracts specifically formatted data such as hyperlinks and e-mail addresses from web pages. It utilizes a method for extracting information that is independent of the specific data encoding or the file format in which the information is stored and is commonly known as “regular expressions”. Regular expressions are a grammar or syntax for specifying any possible textual or information pattern.

The system can be generalized to take regular expressions and Uniform Internet Resource Locators as input, thus enabling the extractor to search for any specified pattern in any internet resource. The extractor also has a means of specifying the level or depth to search for in a given internet resource by an integer. The depth, in the context of the extractor, means that he extractor can follow links to other resources that are referenced in a given resource and apply the same process of extraction to those.

The extractor relies on another component to download internet resources. Using the said component, the extractor can request and download a list of search results from a query engine through a standard communications protocol, whereby the said protocol is used to specify search words and constriction parameters to the query engine.

The extractor as generalized in [0001] relies on an array of key/value collections represented as a programming language data structure to store results. Each key/value collection is associated with a message. It gives the user a means of naming every regular expression (or pattern to be searched for) that the user selects or specifies by a key. The name (or key) and the corresponding values extracted for that key from each individual resource or posting are stored in the key/value collection.

The composer/mailer component of the system comprising the present invention then presents the user with a text field where the user enters his message using the key instead of a definite value for certain words in his message. For example, in the present use for the invention described herein, the user enters “PositionName”(name or key which he specified) where a particular position name or title would go, such as in the sentence “I would like to apply for the position of PositionName”. The mailer/composer then substitutes each key in the message with a particular value, thus constructing a plurality of messages tailored to each posting. It has means of permanently storing the message entered by the user in a data table that contains the user's information including his/hers resume. The mailer/composer then sends each message to its corresponding electronic address which is itself stored in the key/value collection for the message.

The system ensures that only one response is sent to each posting by constructing a unique number from each unit of data extracted and storing it permanently in a table. On subsequent uses of the system, the results are checked against the table and any subsequent results which map to a number that already exists in the table are discarded, the rest of the results are stored in the table.

In an alternate embodiment of the present invention, it can be implemented as a consumer of a web service that provides well-structured data through the use of a descriptor language and a parser that create a local or proxy version of a remote page or document that contains the original document's elements classified in a hierarchic fashion as tag elements containing attributes. The data can be accessed by simply accessing the elements of the proxy that represent different elements of the page or document. Thus the fields or keywords returned by the extractor can be instead directly and readily obtained instead of extracted with regular expressions through the consumption of a web service. Another scenario or embodiment will be the construction and consumption of a web service that returns the results of a database search which comprise postings information in a structured format such as an XML file which will also allow for an easier way of accessing the required data. Thus, the scope of this invention is not limited to the embodiment of the present invention described herein but can find any number of embodiments consistent with achieving the objectives of the process set forth herein. Therefore, the embodiment described herein should not be construed as limiting the scope of the present invention but as merely providing illustrations of the presently preferred embodiments of this invention.

The intended use of the present invention is to automatically download multiple job postings from multiple job boards and automatically create and send responses(including a CV) to the advertising parties but the system can be used and find application in any context where multiple search results or postings can be parsed for certain keywords including the contact address and a response for each one can be constructed and sent. Such applications will not depart from the spirit and scope of the invention and should be obvious to a person versed in the art of the invention.

1. A system comprising of an extractor or parser for the purpose of extracting formatted data from internet or network resources, a composer that uses the extracted or parsed data for the purpose of constructing electronic messages and a mailer that delivers the electronic messages through an electronic mailing or messaging system.

2. The system in claim 1 wherein said system is used in the extraction of job postings residing on a plurality of internet job boards, the construction of responses and job applications to each the said postings based on information extracted by the extractor from the said job postings, and the delivery of said responses and job applications through an electronic mail system to the advertising parties.

3. The system of claim 2 where the job postings returned are narrowed by user specified criteria and key words such as location and job title, years of experience and industry.

4. The system according to claim 2 where the responses constructed are cover letters tailored to a specific job posting by including certain keywords returned by the extractor of claim 1 such as company name and job title in the cover letter.

5. The system of claim 1 wherein the said system has means of querying search engines.
and parsing the returned results from the said search engines to extract individual information from every result.

6. The means of claim 5 wherein the said search engines are comprised of job board search engines.

7. The system of claim1 wherein the said extractor extracts electronic addresses from the said resources.

8. The system according to claim 1 that further has means of managing postings or the relevant information extracted from them by assigning a unique ID to each one and using the said ID to keep track of postings to which the user of the system has already responded.

9. The system according to claim 1 that allows a user of the system to specify the structure of the information to be extracted by the said system by specifying a regular expression and name for the regular expression as well as a single or multiple internet resource locators.

10. The system according to claim 8 that further searches for any information matching the regular expression in the specified internet resources and stores the name of the regular expression and the results associated with the regular expression located in an internet resource in the respective fields of a key/value collection or table.

11. The means according to claim 8 that further comprise the ability to review postings
or the relevant information extracted from them as a set of units and delete selected or deselected units, thus preventing a response to be sent to a selected/deselected unit.
